(19) United States
(12) Patent Application Publication
(10) Pub. No.: US 2026/0148562 A1
(43) Pub. Date: May 28, 2026

(54) METHOD FOR SHARING PRIVATE CAMERA SECURITY VIDEO VIA APPLICATION

(71) Applicant: Tyler Trowbridge, San Diego, CA (US)

(72) Inventor: Tyler Trowbridge, San Diego, CA (US)

(21) Appl. No.: 19/402,569

(22) Filed: Nov. 26, 2025

Related U.S. Application Data
(60) Provisional application No. 63/724,902, filed on Nov. 26, 2024.

(51) Int. Cl. G06V 20/52

(52) U.S. Cl. CPC G06V 20/52

(57) ABSTRACT

A method for streamlining the sharing of video footage from private security cameras, having steps including the generation and transmittal of requests, the accessing and editing of video footage to create restricted footage, the transmittal of restricted footage to become time-limited footage, the deletion of time-limited footage, and the transmittal of restricted footage to become permanent footage. Currently there is a need to enable sharing of private video footage to enable individuals to investigate events that occurred beyond the scope of any security cameras that they own and/or have access to, while also preventing misuse of any footage transmitted. This method allows for the easy request for and transmittal of video footage, while preventing misuse of footage by ensuring that, at least on some requests, the footage is available only for a limited period of time.

### CROSS-REFERENCE TO RELATED PATENT APPLICATIONS

The present application claims the benefit of U.S. Provisional Ser. No. 63/724,902, filed Nov. 26, 2024, the disclosure of which is incorporated herein by this reference in its entirety.

### BACKGROUND OF THE INVENTION

### 1. Field of the invention

Embodiments of the present invention relate generally to personal security cameras and computer applications, and more particularly to computer applications designed to ease the sharing of personal security camera footage between users.

### 2. Description of Related Art

Security cameras in homes have become far more accessible, and it is now commonplace for neighborhoods to have multiple homes equipped with at least one camera. Of course, the nature of any of these cameras is that they are locked into place, and while they may have some ability to change their scope of vision, they are universally limited to the address they are placed at.

As is commonplace, some events may be captured by a personal security camera but not all of the salient events of a particular incident may be caught within the scope of view of a single camera, such as a lost or abducted child or a burglar making his escape with a person's property. In these situations, it would be advantageous for an individual to be able to quickly and easily request and access relevant portions of nearby personal security cameras, such as those of his or her neighbors, to obtain a more complete view of the event, or to watch the continuation of an event as it unfolds in real time.

Currently, obtaining the video footage from another individual's security camera requires a subpoena or individual conversation. Further, the provision of the footage can raise security concerns on the part of the person giving the footage, as it may not be limited to only a certain period of time, and there is no control of the footage after it has been transferred to the requestor. Accordingly, there is a need for a tool that can streamline the process of requesting select portions of security footage, while also providing security features over the footage to prevent misuse.

### SUMMARY OF THE INVENTION

The present invention provides a method embodied in a computer application that allows a user of the application to request security footage from another user based upon geographic location and a particular period of time. The requesting user interacts with the application to create a form encapsulating the request, which is then transferred to the footage-owning user. The footage-owning user is then able to approve or deny the request, based upon the information submitted to them. If the footage-owning user approves the request, the requested footage is transferred via the application to the requesting user, where it is available for review for a limited portion of time. After that time, the video is deleted from the application. If the reviewed footage is useful, the requesting user can make a second request with either the same information or expanded information. The footage-owning user can again approve or deny the second request. If the footage-owning user approves the second request, the sought footage is again transferred to the requesting user via the application, and the requesting user is able to keep the footage indefinitely.

The application can function on traditional computing systems or as a mobile application. The application contains a user interface for selecting a camera based upon camera footage within a geographical location, along with buttons and fields to streamline and ease the creation of the request form, including buttons indicating common reasons for requests and a field to add additional details.

In one embodiment, the application can make recommendations of additional cameras within the network from which to make a request and build a timeline of evidence relevant to the incident necessitating the request to a footage-owning user.

### BRIEF DESCRIPTION OF THE DRAWINGS

FIG. 1 shows a high-level view of the interaction between users, user devices, a web server, and video storage mechanisms;

FIG. 2 shows a flowchart of the steps that embody the method as depicted in FIG. 1; and

FIG. 3 shows a potential, but non-exclusive, example of the application user interface used to create a request.

### DETAILED DESCRIPTION OF EMBODIMENTS

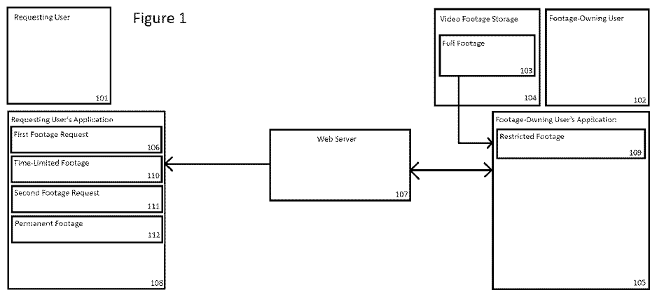

While the invention is illustrated and described in a preferred embodiment, the invention may be produced and described in many different configurations, forms, and various methods. The preferred embodiment of the invention is described in detail below with reference to the accompanying FIGS. 1-3, with the understanding that the present disclosure is to be considered an exemplification of the principles of the invention to the embodiment illustrated. Those skilled in the art will envision many other possible variations within the scope of the invention described herein.

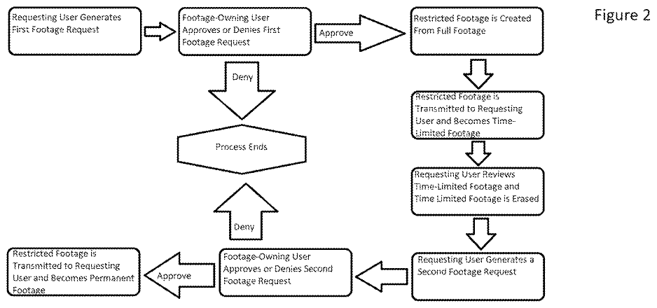

Referring now to FIGS. 1 and 2, a method is disclosed. The method is initiated when a Requesting User 101 has an incident occur necessitating the request of video footage belonging to a Footage-Owning User 102, which it is to be understood may be a plurality of Footage-Owning Users 102 withing a particular geographic region. The incident may take many forms, including, but not limited to, theft, burglary, a lost child, or a lost pet, but all incidents will form a basis for requesting information from the Footage-Owning User 102 where the incident is recorded, at least in part, as a portion of the Full Footage 103.

The Full Footage 103 is contained on the Video Footage Storage 104. The Video Footage Storage may take many forms, including, but not limited to, local storage on a camera or present piece of computer hardware, server, remote storage owned by the Footage-Owning User 102, or remote storage owned and operated by a third party service associated with the camera that captured a portion of the Full Footage 103, but all forms are storages that the Full Footage 103 exists on and that the Footage-User's Application 105 can interact with to request, access, download, or otherwise interact with the Full Footage 103 so that the Footage-User's Application 105 can obtain and edit the Full Footage 103.

Once the instigating event occurs, the Requesting User 101 utilizes the Requesting User Application 108 to generate a First Footage Request 106. The First Footage Request 106 may take many forms including, but not limited to, pre-generated forms, forms with information selected from predetermined options, and/or forms with sections to provide information to, but all will include information identifying the time of the footage being requested.

The First Footage Request 106 is then transferred via a Web Server 107 to the Footage-Owning User 102, who can then approve or deny the First Footage Request 106 based on the information contained within the First Footage Request 106. If the Footage-Owning User 102 denies the First Footage Request 106, the process ends.

If the Footage-Owning User 102 approves the First Footage Request 106, the Footage-User's Application 105 obtains the Full Footage 103 from the Video Footage Storage 104 and edits the footage to contain only the time period enumerated in the First Footage Request 106, creating the Restricted Footage 109. The Restricted Footage 109 is then transferred via Web Server 107 to the Requesting User 101, where the Restricted Footage 109 becomes the Time-Limited Footage 110. The Requesting User 101 may view the Time-Limited Footage 110 for a limited period of time, after which the footage is deleted from the Requesting User's Application 108 and the Video Footage Storage 104.

If the Requesting User 101 feels, after viewing the Time-Limited Footage 110, that the footage is helpful for their purposes, they may use the Requesting User's Application 108 to generate a Second Footage Request 111. The Second Footage Request 111 can take many forms, including, but not limited to, pre-generated forms, forms with information selected from predetermined options, and/or forms with sections to provide information to, but all will include information identifying why the footage is necessary to permanently transmit. If the Footage-Owning User 102 denies the Second Footage Request 111, the process ends.

If the Footage-Owning User 102 approves the Second Footage Request 111, the Footage-User's Application 105 transmits the Restricted Footage 109 via the Web Server 107 to the Requesting User 101, where it becomes the Permanent Footage 112 and stored in the Video Footage Storage 104. The Requesting User 101 is then able to view, use, copy, transfer, and otherwise control the Permanent Footage 112 as they see fit. The Requesting User 101 may edit the Permanent Footage 112 as part of the Full Footage 103 to create an evidentiary timeline of the instigating incident.

The Full Footage 103 may be a recording from a single camera or a plurality of cameras forming an evidentiary timeline of the instigating incident. In one embodiment, the application can make recommendations of additional cameras within the network from which to make a request and build a timeline of evidence relevant to the incident necessitating the request to a footage-owning user. The method assists the Requesting User 101 in coordination with other neighbors that may be a Footage-Owning User 102 from which to make a First Footage Request 106. In this regard, the method contemplates instant push notifications related to incidents in a particular neighborhood enabling users to securely share relevant, real-time footage.

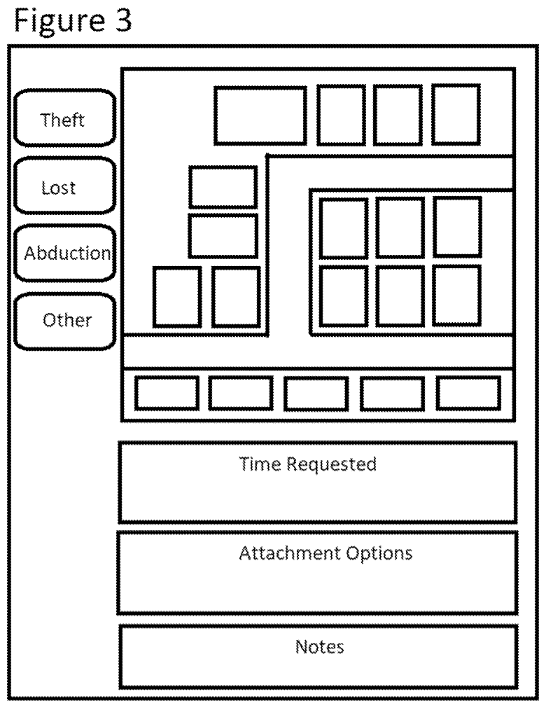

FIG. 3 depicts a non-exclusive exemplary graphical user interface. The user interface may include predetermined buttons for common incidents such as theft, lost pet, abduction, or the like. In addition, the user interface may include a notes section enabling the user to input additional and/or clarifying information relevant to a First Footage Request 106 and/or Second Footage Request 111. The user interface includes a map relevant to a user's neighborhood and identifies the Footage-Owning User(s) 102 from which to make a First Footage Request 106. The user interface may map the Requesting User 101 First Footage Request 106 and/or Second Footage Request 111 and create a visible path from which footage was, or was not, gathered. In this regard, the application may make suggestions of additional Footage-Owning User(s) 102 from which to make a First Footage Request 106 in order to compile a complete Full Footage 103.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent particular aspects and embodiments of the invention are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein.

I claim:

1. A method for the sharing and transmittal of video footage, comprising the steps of:
a triggering incident captured by a camera and stored as video footage;
a requesting user seeking to create video footage of the triggering incident, wherein the requesting user generates a first video footage request, the first video footage request including a request for a segment of video footage over a particular period of time;
transmitting the first video footage request to at least one footage-owning user; and
the footage-owning user approving or denying the first footage request.

2. The method of claim 1, further comprising the steps of:
review by the footage-owning user of a database of video footage captured by at least one camera of the footage-owning user to determine whether the segment of video footage over a particular period of time as requested in the first video footage request is present;
the footage-owning user editing the database of video footage to create a restricted footage covering the segment of video footage over a particular period of time as requested in the first video footage request;
approval of the first video footage request by the footage-owning user; and
the footage-owning user transmitting the restricted footage to the requesting user to create a time-limited footage.

3. The method of claim 2, wherein the time-limited footage is reviewed by the requesting user for a limited period of time and wherein the time-limited footage is deleted after a predetermined period of time has elapsed.

4. The method of claim 3, further comprising the steps of:
the requesting user generating a second video footage request;
transmitting the second video footage request to the footage-owning user;
the footage-owning user approving or denying the second video footage request; and
transmitting the restricted footage to the requesting user to create a permanent footage.

5. The method of claim 4, wherein the triggering incident is a theft, abduction, lost pet, burglary, assault, vandalism.

6. The method of claim 4, wherein the camera is any camera located at a residence or commercial property.

7. The method of claim 4, wherein the database of video footage, restricted footage, time-limited footage, and permanent footage are encrypted.

8. The method of claim 4, wherein the permanent footage is stored in a database in a locate storage, remote storage, or is a remote storage operated by a third party.

9. The method of claim 4, wherein the first video footage request, second video footage request, and the restricted footage are transmitted via a web server.

10. The method of claim 1, further comprising the steps of:
receiving push notifications of incidents located within a specific geographic location of the requesting user and the at least one footage-owning user; and
the requesting user receiving recommendations of available at least one footage-owning users from which to make a first video footage request.

11. The method of claim 10, wherein the push notifications relate to triggering incidents.

12. A method for the sharing and transmittal of video footage, comprising the steps of:
a triggering incident captured by a camera and stored as video footage;
a requesting user seeking to create video footage of the triggering incident, wherein the requesting user generates a first video footage request, the first video footage request including a request for a segment of video footage over a particular period of time;
transmitting the first video footage request to at least one footage-owning user;
the footage-owning user approving or denying the first footage request;
review by the footage-owning user of a database of video footage captured by at least one camera of the footage-owning user to determine whether the segment of video footage over a particular period of time as requested in the first video footage request is present;
the footage-owning user editing the database of video footage to create a restricted footage covering the segment of video footage over a particular period of time as requested in the first video footage request;
approval of the first video footage request by the footage-owning user; and
the footage-owning user transmitting the restricted footage to the requesting user to create a time-limited footage.

13. A method for the sharing and transmittal of video footage, comprising the steps of:
a triggering incident captured by a camera and stored as video footage;
a requesting user seeking to create video footage of the triggering incident, wherein the requesting user generates a first video footage request, the first video footage request including a request for a segment of video footage over a particular period of time;
transmitting the first video footage request to at least one footage-owning user;
the footage-owning user approving or denying the first footage request;
review by the footage-owning user of a database of video footage captured by at least one camera of the footage-owning user to determine whether the segment of video footage over a particular period of time as requested in the first video footage request is present;
the footage-owning user editing the database of video footage to create a restricted footage covering the segment of video footage over a particular period of time as requested in the first video footage request;
approval of the first video footage request by the footage-owning user;
the footage-owning user transmitting the restricted footage to the requesting user to create a time-limited footage;
the requesting user generating a second video footage request;
transmitting the second video footage request to the footage-owning user;
the footage-owning user approving or denying the second video footage request; and
transmitting the restricted footage to the requesting user to create a permanent footage.
